(19) United States
(12) Patent Application Publication
(10) Pub. No.: US 2019/0023273 A1
(43) Pub. Date: Jan. 24, 2019

(54) VEHICLE CONTROL DEVICE, VEHICLE CONTROL METHOD, AND VEHICLE CONTROL PROGRAM

(71) Applicant: HONDA MOTOR CO., LTD., Minato-ku, Tokyo (JP)

(72) Inventor: Atsushi Ishioka, Wako-shi (JP)

(21) Appl. No.: 16/068,904

(22) PCT Filed: Feb. 7, 2017
(86) PCT No.: PCT/JP2017/004358

§ 371 Date: Jul. 10, 2018

(30) Foreign Application Priority Data
Feb. 12, 2016 (JP) 2016-024827

(51) Int. Cl. B60W 30/18; B60W 30/12

(52) U.S. Cl. CPC B60W 30/18163; B60W 30/12; B60W 2720/24; B60W 2720/10; B60W 2550/30

(57) ABSTRACT

A vehicle control device includes a recognition unit that recognizes positions of nearby vehicles traveling around a host vehicle, a respective lane speed specification unit that specifies a first vehicle speed related to a vehicle traveling in a host lane in which the host vehicle is traveling and a second vehicle speed related to the nearby vehicle traveling in a lane that is a lane change destination of lane change to be performed by the host vehicle, a target position setting unit that sets a lane change target position on the lane that is the lane change destination on the basis of a comparison result between the first vehicle speed and the second vehicle speed, and a control unit that causes the host vehicle to move to the target position by lane change.

### TECHNICAL FIELD

The present invention relates to a vehicle control device, a vehicle control method, and a vehicle control program.

Priority is claimed on Japanese Patent Application No. 2016-024827, filed Feb. 12, 2016, the content of which is incorporated herein by reference.

### BACKGROUND ART

In recent years, a technology for automatically performing lane change according to a relative relationship between a host vehicle and a nearby vehicle at the time of traveling has been researched. In relation to this, a travel control device is known that acquires a traffic state including a vehicle density for each lane of a road on which a vehicle travels, changes the lane of the vehicle to a lane having a high vehicle density among the lanes, and performs travel control with respect to the vehicle in the lane having a high vehicle density such that an inter-vehicle distance is unlikely to become short as the vehicle density approaches a critical density (for example, see Patent Literature 1). Furthermore, a display apparatus for a positional relationship of a vehicle is known that detects a position on a road on which a vehicle is running, performs inter-vehicle communication regarding information on the detected position of the vehicle, recognizes the rearmost vehicle in a train of vehicles automatically running around an own vehicle from position information of other vehicles running on an automatic running lane on the same road, which has been received by the inter-vehicle communication, and displays a relative positional relationship between the recognized rearmost vehicle and the own vehicle (for example, see Patent Literature 2).

### CITATION LIST

### Patent Literature

[Patent Literature 1]

Japanese Unexamined Patent Application, First Publication No. 2010-36862

[Patent Literature 2]

Japanese Unexamined Patent Application, First Publication No. 10-103982

### SUMMARY OF INVENTION

### Technical Problem

However, in the related art, there are cases where it is not possible to appropriately set a lane change target position on the basis of situations of a lane that is a lane change destination.

Aspects according to the present invention are achieved in view of the problems described above, and one of the objects of is to provide a vehicle control device, a vehicle control method, and a vehicle control program, by which it is possible to appropriately set a lane change target position.

### Solution to Problem

(1) A vehicle control device according to an aspect of the present invention includes a recognition unit that recognizes positions of nearby vehicles traveling around a host vehicle, a respective lane speed specification unit that specifies a first vehicle speed related to a vehicle traveling in a host lane in which the host vehicle is traveling and a second vehicle speed related to the nearby vehicle traveling in a lane that is a lane change destination of lane change to be performed by the host vehicle, a target position setting unit that sets a lane change target position on the lane that is the lane change destination on the basis of a comparison result between the first vehicle speed and the second vehicle speed, and a control unit that causes the host vehicle to move to the target position by lane change

(2) In the aspect of the aforementioned (1), the target position setting unit may set a first target position at a lateral side of the host vehicle, the vehicle control device may further include a lane change feasibility determination unit that determines whether lane change of the host vehicle to the first target position is possible, and, when it is determined by the lane change feasibility determination unit that the lane change is not possible, the target position setting unit may set a second target position on the basis of the first vehicle speed and the second vehicle speed.

(3) In the aspect of the aforementioned (2), when the first vehicle speed is faster than the second vehicle speed, the target position setting unit may set the second target position in front of the first target position, and when the first vehicle speed is equal to or less than the second vehicle speed, the target position setting unit may set the second target position behind the first target position.

(4) In any one aspect of the aforementioned (1) to (3), the respective lane speed specification unit may specify, as the first vehicle speed, a vehicle speed average value obtained from one or a plurality of nearby vehicles traveling in the host lane and/or the host vehicle, and may specify, as the second vehicle speed, a vehicle speed average value of one or a plurality of nearby vehicles traveling in the lane that is the lane change destination.

(5) In any one aspect of the aforementioned (1) to (4), the respective lane speed specification unit may specify the second vehicle speed by using speed information obtained from a predetermined number of nearby vehicles sequentially near the host vehicle among the nearby vehicles traveling in the lane that is the lane change destination.

(6) In any one aspect of the aforementioned (1) to (5), the respective lane speed specification unit may specify one or both of the first vehicle speed and the second vehicle speed as a fixed value.

(7) In any one aspect of the aforementioned (1) to (6), when the target position is located in front of the host vehicle, the control unit may perform speed adjustment such that the host vehicle approaches the target position while accelerating the host vehicle.

(8) In any one aspect of the aforementioned (1) to (7), when the target position is located behind the host vehicle, the control unit may decelerate the host vehicle, and immediately after the target position is located at a lateral side of the host vehicle, the control unit may perform speed adjustment such that a speed of the host vehicle is equal to the second vehicle speed or a speed of a nearby vehicle travelling in front of or behind the target position.

(9) A vehicle control method according to an aspect of the present invention includes recognizing, by an in-vehicle computer, positions of nearby vehicles traveling around a host vehicle; specifying, by the in-vehicle computer, a first vehicle speed related to a vehicle traveling in a host lane in which the host vehicle is traveling and a second vehicle speed related to the nearby vehicle traveling in a lane that is a lane change destination of lane change to be performed by the host vehicle; setting, by the in-vehicle computer, a lane change target position on the lane that is the lane change destination on the basis of a comparison result between the first vehicle speed and the second vehicle speed; and causing, by the in-vehicle computer, the host vehicle to move to the target position by lane change.

(10) A vehicle control program according to an aspect of the present invention causes an in-vehicle computer to perform a process including recognizing positions of nearby vehicles traveling around a host vehicle, specifying a first vehicle speed related to a vehicle traveling in a host lane in which the host vehicle is traveling and a second vehicle speed related to the nearby vehicle traveling in a lane that is a lane change destination of lane change to be performed by the host vehicle, setting a lane change target position on the lane that is the lane change destination on the basis of a comparison result between the first vehicle speed and the second vehicle speed, and causing the host vehicle to move to the target position by lane change.

### Advantageous Effects of Invention

According to an aspect of the aforementioned (1), (9), and (10), the control unit can appropriately set the lane change target position in the automatic driving control. Consequently, it is possible to perform lane change at an appropriate timing in accordance with travel situations of a vehicle in the lane change destination.

According to the aspect of the aforementioned (2), when the lane change for the set first target position is not possible, the control unit can appropriately set the second target position by using vehicle speed information.

According to the aspect of the aforementioned (3), the control unit can set the second target position at an appropriate position by causing the second target position to correspond to a comparison result of the first vehicle speed and the second vehicle speed.

According to the aspect of the aforementioned (4), the control unit can specify, as the first vehicle speed, a vehicle speed average value obtained from one or a plurality of nearby vehicles traveling in the host lane and/or the host vehicle, and specify, as the second vehicle speed, a vehicle speed average value of one or a plurality of nearby vehicles traveling in the lane that is the lane change destination, thereby precisely specifying speeds of each lane.

According to the aspect of the aforementioned (5), the control unit can specify the second vehicle speed by using speed information obtained from nearby vehicles traveling in the vicinity of the target area. Consequently, it is possible to set the second target position at a more appropriate position.

According to the aspect of the aforementioned (6), the control unit can specify one or both of the first vehicle speed and the second vehicle speed as a fixed value, thereby quickly specifying vehicle speeds.

According to the aspect of the aforementioned (7), the control unit can allow the host vehicle to be quickly positioned at the lateral side of the target position and reduce an increase/decrease of a speed in subsequent lane change, thereby performing smooth lane change.

According to the aspect of the aforementioned (8), the control unit can allow the host vehicle to be quickly positioned at the lateral side of the target position, and immediately after the target position is located at a lateral side of the host vehicle, the control unit can perform speed adjustment such that a speed of the host vehicle is equal to the second vehicle speed or a speed of a nearby vehicle travelling in front of or behind the target position, thereby reducing an increase/decrease of a speed in subsequent lane change and thus performing smooth lane change.

### BRIEF DESCRIPTION OF DRAWINGS

FIG. 1 is a diagram representing elements of a vehicle in which a vehicle control system according to a first embodiment is installed.

FIG. 2 is a functional configuration diagram of a host vehicle in which the vehicle control system according to the first embodiment is installed.

FIG. 3 is a diagram representing a mode in which a relative position of the host vehicle with respect to a travel lane is recognized by a host vehicle position recognition unit.

FIG. 4 is a diagram representing an example of an action plan generated in a certain section.

FIG. 5A is a diagram representing an example of a track generated by a first track generation unit.

FIG. 5B is a diagram representing an example of a track generated by the first track generation unit.

FIG. 5C is a diagram representing an example of a track generated by the first track generation unit.

FIG. 5D is a diagram representing an example of a track generated by the first track generation unit.

FIG. 6 is a diagram representing a mode in which a target position setting unit sets a target position in the first embodiment.

FIG. 7 is a diagram representing a mode in which a second track generation unit generates a track in the first embodiment.

FIG. 8 is a diagram explaining interference determination between a target track of a host vehicle and a predicted track of another vehicle.

FIG. 9 is a flowchart representing an example of a lane change control process.

FIG. 10 is a flowchart representing an example of a lane change feasibility determination process in the first embodiment.

FIG. 11 is a flowchart representing an example of a target position change process.

FIG. 12 is a diagram explaining a mode in which a target position is changed forward.

FIG. 13 is a diagram explaining a mode in which a target position is changed backward.

FIG. 14 is a flowchart representing an example of a lane change feasibility determination process in a second embodiment.

### DESCRIPTION OF EMBODIMENTS

Hereinafter, embodiments of a vehicle control device, a vehicle control method, and a vehicle control program of the present invention will be described with reference to the drawings.

### First Embodiment

[Vehicle Configuration]

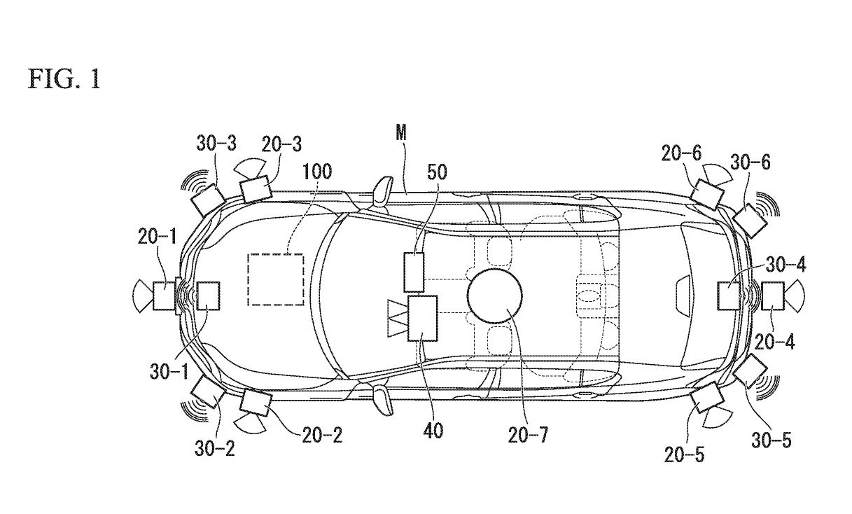

FIG. 1 is a diagram representing elements of a vehicle in which a vehicle control system 1 according to a first embodiment is installed (hereinafter, referred to as a host vehicle M). The vehicle in which the vehicle control system 1 is installed is, for example, a car with two wheels, three wheels, four wheels and the like, and includes a car employing an internal combustion engine such as a diesel engine and a gasoline engine as a power source, an electric car employing an electric motor as a power source, a hybrid car having both an internal combustion engine and an electric motor, and the like. The aforementioned electric car, for example, is driven using power discharged by a cell such as a secondary cell, a hydrogen fuel cell, a metal fuel cell, and an alcohol fuel cell.

As illustrated in FIG. 1, finders 20-1 to 20-7, radars 30-1 to 30-6, a sensor such as a camera 40, a navigation device 50, and a vehicle control device 100 are installed in the host vehicle M. The finders 20-1 to 20-7, for example, use a light detection and ranging or laser imaging detection and ranging (LIDAR) in which scattered light from radiated light is measured to measure a distance to an object. For example, the finder 20-1 is mounted at a front grill and the like, and the finders 20-2 and 20-3 are mounted on side surfaces or side mirrors of a vehicle body, inside headlights, around side lights, and the like. The finder 20-4 is mounted at a trunk lid and the like, and the finders 20-5 and 20-6 are mounted on side surfaces of the vehicle body, inside tail lights, and the like. The aforementioned finders 20-1 to 20-6, for example, each has a detection area of about 150° with respect to a horizontal direction. Furthermore, the finder 20-7 is mounted at a roof and the like. The finder 20-7, for example, has a detection area of about 360° with respect to the horizontal direction.

The aforementioned radars 30-1 and 30-4, for example, are long range millimeter wave radars in which detection areas in a depth direction are wider than those of the other radars. Furthermore, the radars 30-2, 30-3, 30-5, and 30-6 are middle range millimeter wave radars in which detection areas in the depth direction are narrower than those of the radars 30-1 and 30-4. Hereinafter, when the finders 20-1 to 20-7 are not specifically distinguished from one another, they are simply referred to as a “finder 20”, and when the radars 30-1 to 30-6 are not specifically distinguished from one another, they are simply referred to as a “radar 30”. The radar 30, for example, detects the presence or absence of an object (for example, a nearby vehicle (another vehicle), an obstacle and the like) near the host vehicle M, a distance to the object, a relative speed and the like by frequency modulated continuous wave (FM-CW) scheme and the like.

The camera 40, for example, is a digital camera using a solid-state imaging element such as a charge coupled device (CCD) and a complementary metal oxide semiconductor (CMOS). The camera 40 is mounted at an upper part of a front wind shield, on a rear surface of a rear view mirror, and the like. The camera 40, for example, regularly and repeatedly captures an image of an area in front of the host vehicle M.

The constituents illustrated in FIG. 1 are merely an example, and some of the constituents may be omitted or different constituents may be added.

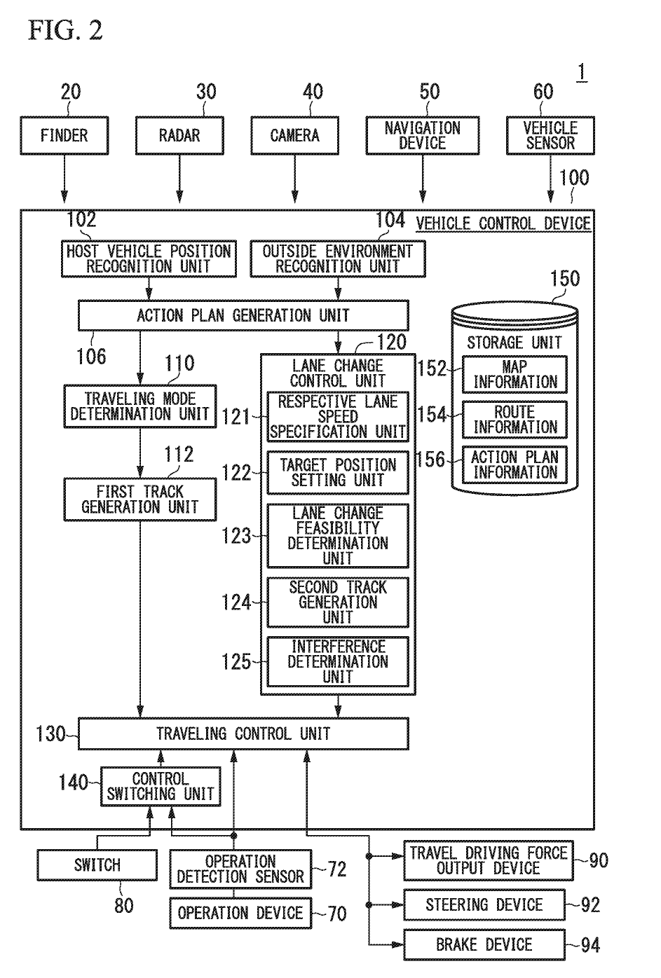

FIG. 2 is a functional configuration diagram of the host vehicle M in which the vehicle control system 1 according to the first embodiment is installed. A navigation device 50, a vehicle sensor 60, an operation device 70, an operation detection sensor 72, a switch 80, a travel driving force output device 90, a steering device 92, a brake device 94, and the vehicle control device 100 are installed in the host vehicle M, in addition to the finder 20, the radar 30, and the camera 40. The above devices and equipments are connected to one another by a multiplex communication line such as a controller area network (CAN) communication line, a serial communication line, a wireless communication network and the like.

The navigation device 50 has a global navigation satellite system (GNSS) receiver, map information (a navigation map), a touch panel type display device serving as a user interface, a speaker, a microphone and the like. The navigation device 50 specifies a position of the host vehicle M with the GNSS receiver and derives a route to a destination designated by a user from the position. The route derived by the navigation device 50 is stored in a storage unit 150 as route information 154. The position of the host vehicle M may be specified or complemented by an inertial navigation system (INS) using the output of the vehicle sensor 60. Furthermore, when the vehicle control device 100 performs a manual driving mode, the navigation device 50 shows the route to the destination by sound or navigation display. In addition, an element for specifying the position of the host vehicle M may be provided independently from the navigation device 50. Furthermore, the navigation device 50, for example, may be realized as one function of a terminal device such as a smart phone and a tablet terminal owned by a user. In this case, information is transmitted and received between the terminal device and the vehicle control device 100 by wireless or wired communication.

The vehicle sensor 60 includes a vehicle speed sensor that detects a vehicle speed of the host vehicle M, an acceleration sensor that detects an acceleration, a yaw rate sensor that detects an angular velocity around a vertical axis, a direction sensor that detects a direction of the host vehicle M, and the like.

The operation device 70, for example, includes an accelerator pedal, a steering wheel, a brake pedal, a shift lever and the like. The operation detection sensor 72 that detects the presence or absence or the amount of an operation by a driver is mounted on the operation device 70. The operation detection sensor 72, for example, includes an accelerator opening sensor, a steering torque sensor, a brake sensor, a shift position sensor and the like. The operation detection sensor 72 outputs an accelerator opening, steering torque, a brake stepping quantity, a shift position and the like to a traveling control unit 130 as a detection result. Instead of this, the detection result of the operation detection sensor 72 may be directly output to the travel driving force output device 90, the steering device 92, or the brake device 94.

The switch 80 is a switch operated by a driver and the like. The switch 80 receives an operation of the driver and the like, generates a control mode designation signal that designates a control mode of the traveling control unit 130 as any one of an automatic driving mode and a manual driving mode, and outputs the control mode designation signal to a control switching unit 140. The automatic driving mode is a driving mode in which a driver travels in a state in which the driver performs no operation (or an operation amount is lower than that in the manual driving mode or operation frequency is low). More specifically, the automatic driving mode is a driving mode in which some or all of the travel driving force output device 90, the steering device 92, and the brake device 94 are controlled on the basis of an action plan.

The travel driving force output device 90, for example, includes an engine and an engine electric control unit (ECU) that controls the engine when the host vehicle M is a car employing an internal combustion engine as a power source, includes a traveling motor and a motor ECU for controlling the traveling motor when the host vehicle M is an electric car employing an electric motor as a power source, and includes the engine, the engine ECU, the traveling motor, and the motor ECU when the host vehicle M is a hybrid car. When the travel driving force output device 90 includes only the engine, the engine ECU adjusts a throttle opening of the engine, a shift stage and the like according to information input from the traveling control unit 130 to be described later, and outputs travel driving force (torque) for a vehicle to travel. Furthermore, when the travel driving force output device 90 includes only the traveling motor, the motor ECU adjusts a duty ratio of a PWM signal applied to the traveling motor according to information input from the traveling control unit 130, and outputs the aforementioned travel driving force. Furthermore, when the travel driving force output device 90 includes the engine and the traveling motor, both the engine ECU and the motor ECU control the travel driving force in cooperation with each other according to information input from the traveling control unit 130.

The steering device 92, for example, includes an electric motor. The electric motor, for example, changes a direction of a turning wheel by allowing force to act on a rack and pinion function and the like. The steering device 92 drives the electric motor according to information input from the traveling control unit 130, thereby changing the direction of the turning wheel.

The brake device 94, for example, is an electric servo brake device including a brake caliper, a cylinder for transmitting oil pressure to the brake caliper, an electric motor for generating the oil pressure in the cylinder, and a brake control unit. The brake control unit of the electric servo brake device controls the electric motor according to information input from the traveling control unit 130, thereby allowing brake torque corresponding to a brake operation to be output to each wheel. The electric servo brake device may have a backup mechanism for transmitting oil pressure generated by an operation of the brake pedal to the cylinder via a master cylinder. In addition, the brake device 94 is not limited to the aforementioned electric servo brake device, and may be an electronic control oil pressure brake device. The electronic control oil pressure brake device controls an actuator according to information input from the traveling control unit 130, thereby transmitting oil pressure of the master cylinder to the cylinder. Furthermore, the brake device 94 may include a regenerative brake by a traveling motor which may be included in the travel driving force output device 90.

[Vehicle Control Device]

Hereinafter, the vehicle control device 100 will be described. The vehicle control device 100 is an example of a “control unit”.

The vehicle control device 100, for example, includes a host vehicle position recognition unit 102, an outside environment recognition unit 104, an action plan generation unit 106, a traveling mode determination unit 110, a first track generation unit 112, a lane change control unit 120, an operation request unit 128, the traveling control unit 130, the control switching unit 140, and the storage unit 150. Some or all of the host vehicle position recognition unit 102, the outside environment recognition unit 104, the action plan generation unit 106, the traveling mode determination unit 110, the first track generation unit 112, the lane change control unit 120, the operation request unit 128, the traveling control unit 130, and the control switching unit 140 are software function units that operate when a processor such as a central processing unit (CPU) executes a program. Some or all of these function units may be hardware function units such as a large scale integration (LSI) and an application specific integrated circuit (ASIC). Furthermore, the storage unit 150 is realized by a read only memory (ROM), a random access memory (RAM), a hard disk drive (HDD), a flash memory and the like. The program executed by the processor may be stored in the storage unit 150 in advance, or may be downloaded from an external device via an in-vehicle Internet facility and the like. Furthermore, the program may be installed in the storage unit 150 when a portable storage medium stored with the program is mounted in a drive device (not illustrated). In this way, the aforementioned hardware function units and the software including the program and the like can cooperate with each other through an in-vehicle computer of the host vehicle M, so that it is possible to perform various processes in the first embodiment.

The host vehicle position recognition unit 102 recognizes a lane in which the host vehicle M is traveling (a travel lane or a host lane) and a relative position of the host vehicle M with respect to a travel lane on the basis of map information 152 stored in the storage unit 150 and information input from the finder 20, the radar 30, the camera 40, the navigation device 50, or the vehicle sensor 60. The map information 152, for example, is higher precision map information than the navigation map of the navigation device 50, and includes information on the center of a lane, information on the boundary of the lane, and the like. More specifically, the map information 152 includes road information, traffic regulation information, address information (addresses and postal codes), facility information, telephone number information and the like. The road information includes information indicating the type of a road such as an expressway, a toll road, a national highway, and a prefectural road, and information indicating the number of lanes of a road, widths of each lane, a slope of a road, a position (a three-dimensional coordinate including a longitude, a latitude, and a height) of a road, a curvature of a curve of a lane, positions of merging and branch points of a lane, signs provided on a road, and the like. The traffic regulation information includes information on lane blocking due to construction, traffic accidents, congestion and the like.

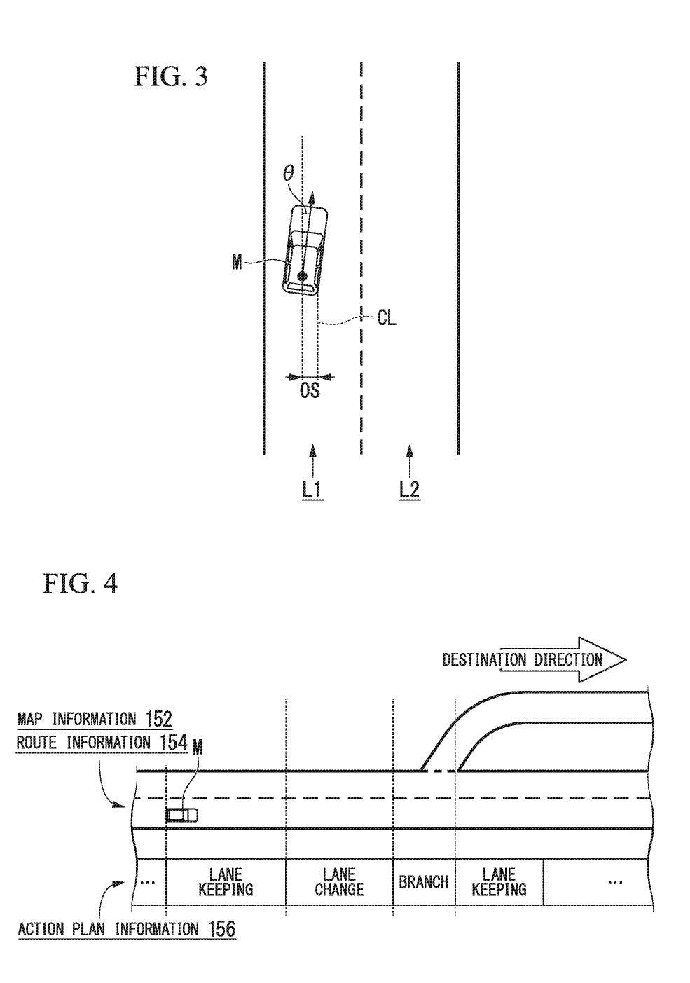

FIG. 3 is a diagram representing a mode in which the relative position of the host vehicle M with respect to a travel lane L1 is recognized by the host vehicle position recognition unit 102. The host vehicle position recognition unit 102, for example, recognizes, as the relative position of the host vehicle M with respect to the travel lane L1, separation OS from a travel lane center CL of a reference point (for example, a centroid) of the host vehicle M, and an angle θ formed between a line connecting the travel lane center CL and the travel direction of the host vehicle M. Instead of this, the host vehicle position recognition unit 102 may recognize the position and the like of the reference point of the host vehicle M with respect to any side end portions of the host lane L1 as the relative position of the host vehicle M with respect to the travel lane.

The outside environment recognition unit 104 recognizes states of a position, a speed, an acceleration and the like of a nearby vehicle on the basis of information input from the finder 20, the radar 30, the camera 40 and the like. In the first embodiment, the nearby vehicle, for example, is another vehicle traveling in the vicinity of the host vehicle M and is a vehicle traveling in the same direction as the host vehicle M. The position of the host vehicle M, for example, may be represented by a representative point of a centroid, a corner and the like of another vehicle, or may be represented by an area expressed by an outline of the other vehicle. The “state” of the nearby vehicle may include information on whether the acceleration and the lane of the nearby vehicle are changed on the basis of information on various devices (or whether a lane change is intended to be performed). Furthermore, the “state” of the nearby vehicle may include information on a distance between the host vehicle M and the nearby vehicle. Furthermore, the outside environment recognition unit 104 may recognize positions of a guardrail, a telegraph pole, a parked vehicle, a pedestrian, and other objects, in addition to the nearby vehicle. In addition, the aforementioned host vehicle position recognition unit 102 and outside environment recognition unit 104 are an example of a “recognition unit”.

The action plan generation unit 106 sets a start point of automatic driving and/or a destination of the automatic driving. The start point of the automatic driving may be a current position of the host vehicle M or a point at which an operation instructing the automatic driving has been performed. The action plan generation unit 106 generates an action plan in a section between the start point and the destination of the automatic driving. The present invention is not limited thereto, and the action plan generation unit 106 may generate the action plan in an arbitrary section.

The action plan, for example, is configured of a plurality of events to be sequentially performed. The events, for example, include a deceleration event of decelerating the host vehicle M, an acceleration event of accelerating the host vehicle M, a lane keeping event of allowing the host vehicle M to travel without departing from a travel lane, a lane change event of changing the travel lane, a passing event of allowing the host vehicle M to pass a front traveling vehicle, a branch event of changing the host vehicle M to a desired lane at a branch point or causing the host vehicle M to travel without departing from a current travel lane, a merging event of causing the host vehicle M to accelerate/decelerate in a merging lane for merging to a main lane and changing the travel lane, and the like.

For example, when there is a junction (a branch point) on a toll road (for example, an expressway), the vehicle control device 100 needs to change lanes or keep in a lane in the automatic driving mode such that the host vehicle M runs in the direction of a destination. Accordingly, when it is determined that there is a junction on a road with reference to the map information 152, the action plan generation unit 106 sets the lane change event of changing to a desired lane in which the host vehicle M can run in the direction of the destination between the current position (coordinate) of the host vehicle M and the position (coordinate) of the junction. Information indicating the action plan generated by the action plan generation unit 106 is stored in the storage unit 150 as action plan information 156.

FIG. 4 is a diagram representing an example of an action plan generated in a certain section. As illustrated in FIG. 4, the action plan generation unit 106 classifies scenes generated when traveling along a route to a destination and generates an action plan such that events according to respective scenes are performed. The action plan generation unit 106 may dynamically change an action plan in accordance with a change in the situation of the host vehicle M.

The action plan generation unit 106, for example, may change (update) the generated action plan on the basis of the state of the outside environment recognized by the outside environment recognition unit 104. In general, while a vehicle is traveling, the state of the outside environment continuously changes. Particularly, when the host vehicle M travels on a road including a plurality of lanes, distance intervals with other vehicles relatively change. For example, when a front vehicle decelerates by abrupt braking or a vehicle traveling in a next lane cuts in front of the host vehicle M, the host vehicle M needs to travel while appropriately changing a speed or a lane according to the behavior of the front vehicle or the behavior of a vehicle in an adjacent lane. Accordingly, the action plan generation unit 106 may change an event set in each control section, in accordance with the aforementioned change in the state of the outside environment.

Specifically, when a speed of another vehicle recognized by the outside environment recognition unit 104 during vehicle traveling exceeds a threshold value or a movement direction of another vehicle traveling in a lane (hereinafter, referred to as an “adjacent lane”) adjacent to a host lane is directed to a host lane direction, the action plan generation unit 106 changes an event set in a driving section in which the host vehicle M will travel. For example, in a case where an event is set such that the lane change event is performed after the lane keeping event, when it is determined by a recognition result of the outside environment recognition unit 104 that a vehicle is running at a speed equal to or more than a threshold value from a rear side of a lane that is a lane change destination during the lane keeping event, the action plan generation unit 106 changes a next event of the lane keeping event to the deceleration event, the lane keeping event and the like from lane change. As a consequence, the vehicle control device 100 can allow the host vehicle M to travel stably and automatically even though there is a change in the state of the outside environment.

[Lane Keeping Event]

When the lane keeping event included in the action plan is performed by the traveling control unit 130, the traveling mode determination unit 110 determines a travel mode of any one of constant speed travel, following travel, deceleration travel, curve travel, obstacle avoiding travel and the like. For example, when there are no other vehicles in front of the host vehicle M, the traveling mode determination unit 110 determines the travel mode to the constant speed travel. Furthermore, when following a front traveling vehicle, the traveling mode determination unit 110 determines the travel mode to the following travel. Furthermore, when deceleration of a front traveling vehicle is recognized by the outside environment recognition unit 104 or when an event such as stopping and parking is performed, the traveling mode determination unit 110 determines the travel mode to the deceleration travel. Furthermore, when the outside environment recognition unit 104 recognizes that the host vehicle M comes to a curved road, the traveling mode determination unit 110 determines the travel mode to the curve travel. Furthermore, when the outside environment recognition unit 104 recognizes an obstacle in front of the host vehicle M, the traveling mode determination unit 110 determines the travel mode to the obstacle avoiding travel.

The first track generation unit 112 generates a track on the basis of the travel mode determined by the traveling mode determination unit 110. The track indicates a set (a trajectory) of points obtained by sampling future target positions, which are assumed to be reached, at every predetermined time when the host vehicle M travels on the basis of the travel mode determined by the traveling mode determination unit 110. The first track generation unit 112 calculates a target speed of the host vehicle M on the basis of a speed of a target object existing in front of the host vehicle M and a distance between the host vehicle M and the target object, which are recognized by at least the host vehicle position recognition unit 102 or the outside environment recognition unit 104. The first track generation unit 112 generates a track on the basis of the calculated target speed. The target object includes a front traveling vehicle, points such as a merging point, a branch point, and a target point, an object such as an obstacle, and the like.

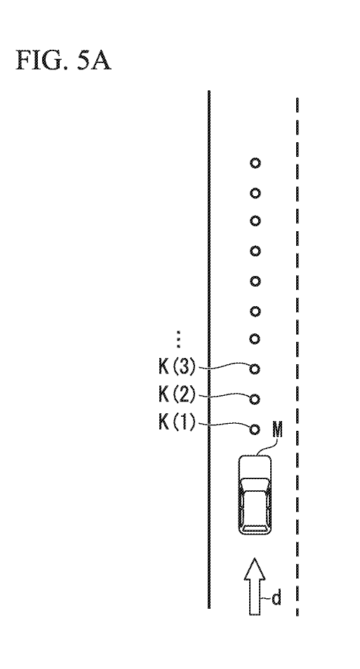

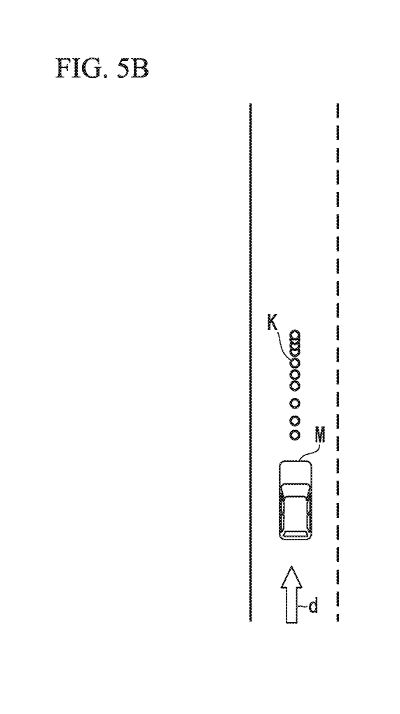

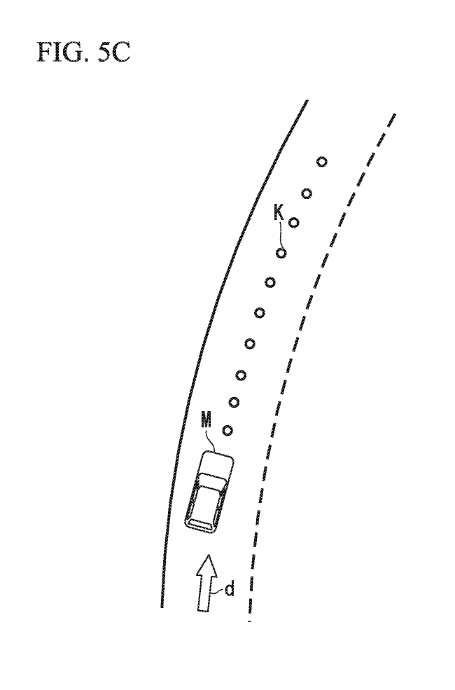

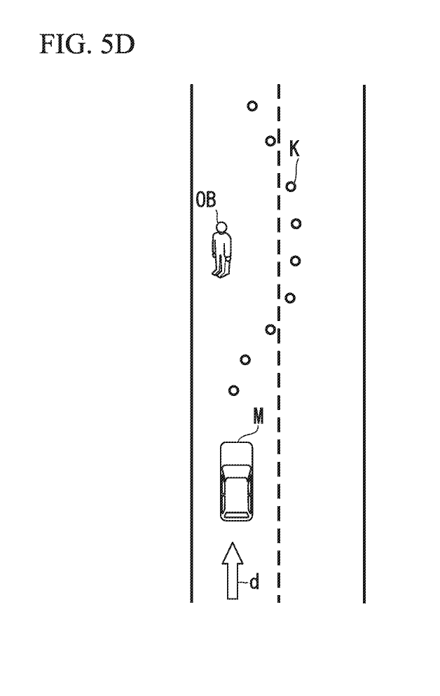

Hereinafter, a description will be provided for track generation when the existence of a target object is not particularly considered and is considered. FIG. 5A to FIG. 5D are diagrams representing an example of a track generated by the first track generation unit 112. As illustrated in FIG. 5A, for example, the first track generation unit 112 employs a current position of the host vehicle M as a reference, and sets, as a track of the host vehicle M, future target positions of K (1), K (2), K (3), . . . whenever a predetermined time Δt passes from a current time. Hereinafter, when these target positions are not distinguished from one another, they are simply written as “track points K”. For example, the number of track points K is determined in accordance with a target time T. For example, when the target time T is set to 5 seconds, the first track generation unit 112 sets the track points K on a center line of a travel lane at an interval of the predetermined time Δt (for example, 0.1 seconds) during 5 seconds, and determines an arrangement interval of the plurality of track points K on the basis of a travel mode. For example, the first track generation unit 112 may derive the center line of the travel lane from information on a width and the like of a lane included in the map information 152, or when information on a position of the center line is included in the map information 152 in advance, the first track generation unit 112 may acquire the center line of the travel lane from the map information 152.

For example, when the travel mode is determined to the constant speed travel by the aforementioned traveling mode determination unit 110, the first track generation unit 112 generates a track by setting the plurality of track points K at an equal interval as illustrated in FIG. 5A.

Furthermore, when the travel mode is determined to be the deceleration travel by the traveling mode determination unit 110 (including when a front traveling vehicle decelerates in the following travel), the first track generation unit 112 generates a track by widening an interval for a track point K with an earlier arrival time and narrowing an interval for a track point K with a delayed arrival time, as illustrated in FIG. 5B. In this case, a front traveling vehicle may be set to a target object, or points such as a merging point, a branch point, and a target point, an obstacle and the like, other than the front traveling vehicle, may be set to the target object. In this way, since the track point K, at which an arrival time from the host vehicle M is delayed, approaches the current position of the host vehicle M, the traveling control unit 130, which will be described later, decelerates the host vehicle M.

Furthermore, as illustrated in FIG. 5C, when a road is a curved road, the traveling mode determination unit 110 determines the travel mode to the curve travel. In this case, the first track generation unit 112, for example, generates a track by arranging a plurality of track points K while changing a lateral position (a position in a lane width direction) for a progress direction of the host vehicle M according to the curvature of a road. Furthermore, as illustrated in FIG. 5D, when there is a person or an obstacle OB such as a stopped vehicle on a road in front of the host vehicle M, the traveling mode determination unit 110 determines the travel mode to the obstacle avoiding travel. In this case, the first track generation unit 112 generates a track by arranging a plurality of track points K so as to travel while avoiding the obstacle OB.

[Lane Change Event]

The lane change control unit 120 performs control when an event (the lane change event) for automatically performing lane change included in the action plan is performed by the traveling control unit 130. The lane change control unit 120, for example, includes a respective lane speed specification unit 121, a target position setting unit 122, a lane change feasibility determination unit 123, a second track generation unit 124, and an interference determination unit 125. When the branch event and the merging event are performed by the traveling control unit 130, the lane change control unit 120 may perform processes to be described later.

The respective lane speed specification unit 121 specifies a first vehicle speed in a lane in which the host vehicle M is traveling and a second vehicle speed of a nearby vehicle traveling in a target lane that is a lane change destination. The first vehicle speed is a vehicle speed average value obtained from one or a plurality of nearby vehicles (for example, nearby vehicle immediately before and immediately after the host vehicle M) traveling in a host lane; however, the present invention is not limited thereto. For example, the first vehicle speed may be a speed of the host vehicle M or an average value of the speed of the host vehicle M and the speeds of the one or plurality of nearby vehicles traveling in the host lane. The second vehicle speed, for example, is an average value of speeds of one or a plurality of nearby vehicles traveling in the lane that is the lane change destination; however, the present invention is not limited thereto. The respective lane speed specification unit 121, for example, may specify the second vehicle speed by using speed information obtained from a predetermined number of (for example, three) nearby vehicles near the host vehicle M among the one or plurality of nearby vehicles traveling in the lane that is the lane change destination, or may specify a speed of one nearby vehicle traveling in the lane that is the lane change destination as the second vehicle speed.

Furthermore, the respective lane speed specification unit 121 may specify one or both of the first vehicle speed and the vehicle second vehicle speed as a fixed value. In this case, the respective lane speed specification unit 121, for example, may specify a vehicle speed of a travel lane, other than a passing lane, as a first fixed value (for example, about 80 km/h) and specify a vehicle speed of the passing lane as a second fixed value (for example, 100 km/h).

In addition, the specifying of the vehicle speed of each lane in the respective lane speed specification unit 121 may not be repeatedly performed during the traveling of the host vehicle M, and for example, may be controlled to be performed when the lane change is determined not to be possible in feasibility determination of the lane change feasibility determination unit 123.

The target position setting unit 122 sets a target position TA of lane change on the lane that is the lane change destination in which the host vehicle M automatically performs the lane change. For example, the target position setting unit 122 specifies a vehicle, which travels in an adjacent lane adjacent to a lane (the host lane) in which the host vehicle M travels and travels in front of the host vehicle M, and a vehicle, which travels in the adjacent lane and travels behind the host vehicle M, and sets the target position TA between these vehicles. The adjacent lane, for example, is a lane that is a lane change destination based on the action plan generated by the action plan generation unit 106. Hereinafter, for convenience of description, the vehicle which travels in the adjacent lane and travels in front of the host vehicle M is called a front reference vehicle, and the vehicle which travels in the adjacent lane and travels behind the host vehicle M is called a rear reference vehicle. The target position TA is a relative area based on a positional relationship between the host vehicle M and the front reference vehicle/the rear reference vehicle.

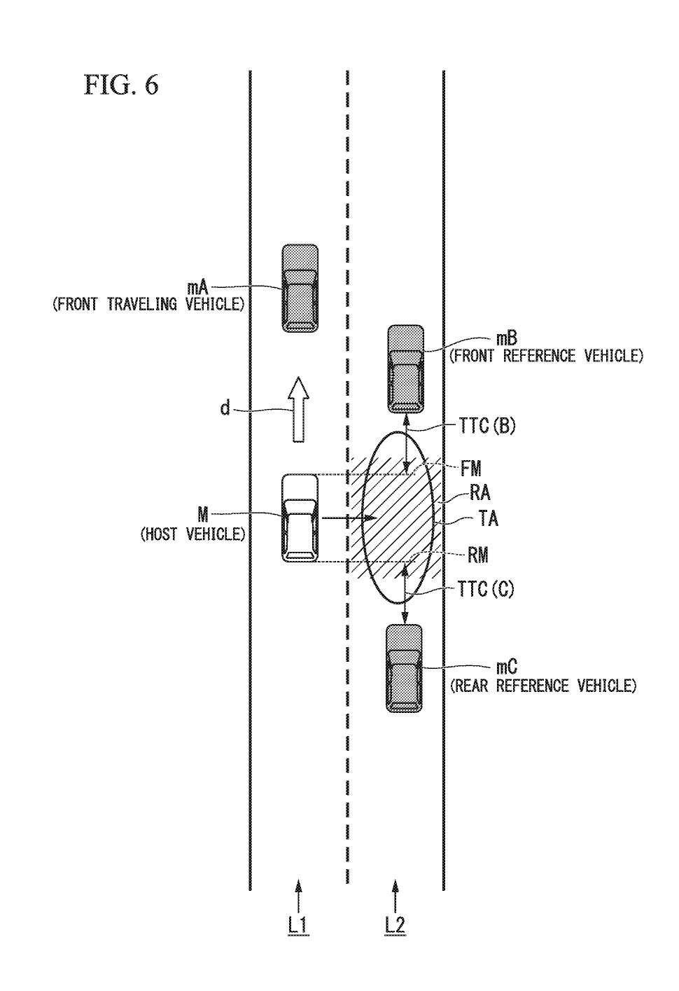

FIG. 6 is a diagram representing a mode in which the target position setting unit 122 sets the target position TA in the first embodiment. In FIG. 6, mA denotes a front traveling vehicle traveling immediately before the host vehicle M, mB denotes a front reference vehicle, and mC denotes a rear reference vehicle. Furthermore, an arrow d denotes a progress (travel) direction of the host vehicle M, L1 denotes a host lane, and L2 denotes an adjacent lane. In the case of the example of FIG. 6, the target position setting unit 122 sets the target position TA (a first target position) between the front reference vehicle mB and the rear reference vehicle mC on the adjacent lane L2. That is, the front reference vehicle mB is a vehicle traveling immediately before the target position TA, and the rear reference vehicle mC is a vehicle traveling immediately after the target position TA.

Furthermore, when it is determined by the lane change feasibility determination unit 123 to be described later that lane change is not possible for the set target position TA (the first sets target position), the target position setting unit 122 changes (re-sets) the target position TA. In this case, the target position setting unit 122 changes the target position (sets a second target position) by using information on the first vehicle speed and the second vehicle speed obtained by the aforementioned respective lane speed specification unit 121.

In the first embodiment, for example, when satisfying both a first condition in which there is no nearby vehicle in an inhibition area which is positioned at a side of the host vehicle M and is set on the lane that is the lane change destination, and a second condition in which a time to collision (TTC) between the host vehicle M and nearby vehicles existing before and after the target position is equal to or more than a threshold value, the lane change feasibility determination unit 123 determines that lane change is possible as primary determination.

With reference to FIG. 6, the feasibility determination of the lane change will be described in detail. As described above, the lane change feasibility determination unit 123 determines whether lane change to the target position TA (that is, between the front reference vehicle mB and the rear reference vehicle mC) set by the target position setting unit 122 is possible. In this case, the lane change feasibility determination unit 123 projects the host vehicle M onto the lane L2 serving as the lane change destination, and sets an inhibition area RA having a slight margin distance back and forth. The inhibition area RA is set as an area extending from one end to the other end in the lateral direction of the lane L2.

When a part of nearby vehicles (the front reference vehicle mB and the rear reference vehicle mC) exists in the inhibition area RA, the lane change feasibility determination unit 123 determines that the lane change to the target position TA is not possible. The inhibition area RA may be set be “7.0 m+offset 4.5 m” in the front direction and “7.0 m+offset 1.0 m” in the rear direction from the centroid or the rear wheel shaft center of the host vehicle M.

Furthermore, when there are no nearby vehicles in the inhibition area RA, the lane change feasibility determination unit 123 determines whether the lane change is possible, on the basis of a time to collision TTC (B) between the host vehicle M and the front reference vehicle mB and a time to collision TTC (C) between the host vehicle M and the rear reference vehicle mC.

For example, as illustrated in FIG. 6, the lane change feasibility determination unit 123 assumes an extension line FM and an extension line RM obtained by virtually extending the front end and the rear end of the host vehicle M to a side of the lane L2 serving as the lane change destination.

The extension line FM is a line obtained by virtually extending the front end of the host vehicle M, and the extension line RM is a line obtained by virtually extending the rear end of the host vehicle M. The lane change feasibility determination unit 123 calculates the time to collision TTC (B) between the extension line FM and the front reference vehicle mB and the time to collision TTC (C) between the extension line RM and the rear reference vehicle mC.

The time to collision TTC (B) is a time derived by dividing a distance (an inter-vehicle distance) between the extension line FM and the rear end of the front reference vehicle mB by a relative speed of the host vehicle M and the front reference vehicle mB. The time to collision TTC (C) is a time derived by dividing a distance (an inter-vehicle distance) between the extension line RM and the front end of the rear reference vehicle mC by a relative speed of the host vehicle M and the rear reference vehicle mC. The aforementioned inter-vehicle distances may be calculated employing a centroid or a rear wheel shaft center of each vehicle as a reference.

When the time to collision TTC (B) is larger than a threshold value Th (B) and the time to collision TTC (C) is larger than a threshold value Th (C), the lane change feasibility determination unit 123 determines that lane change of the host vehicle M to the target position TA is possible as primary determination. The aforementioned threshold values Th (B) and Th (C), for example, may be set by the speed of the host vehicle M or set in accordance with a legal speed limit of a road during traveling. The threshold values Th (B) and Th (C) may be the same value or values different from each other. The threshold values Th (B) and Th (C), for example, are 2.0 seconds. A case where one or both of the aforementioned front reference vehicle mB and rear reference vehicle mC do not exist is assumed. In such a case, even though it is not possible to calculate a time to collision for the non-existing vehicle, the lane change feasibility determination unit 123 performs the lane change feasibility determination by determining that the time to collision is larger than a threshold value.

When it is determined as the primary determination that the lane change of the host vehicle M to the target position TA is possible as the primary determination, the second track generation unit 124 generates a track for the lane change to the target position TA. The track indicates a set (a trajectory) of track points K obtained by sampling future target positions, which are assumed to be reached, at every predetermined time when the lane of the host vehicle M is changed to the lane that is the lane change destination.

In addition, the lane change feasibility determination unit 123 may determine whether the lane change of the host vehicle M to the target position TA is possible, by using information on speeds, accelerations, or jerks of a front traveling vehicle mA, the front reference vehicle mB, and the rear reference vehicle mC. For example, when it is expected that the speeds of the front reference vehicle mB and the rear reference vehicle mC are larger than that of the front traveling vehicle mA and the front reference vehicle mB and the rear reference vehicle mC pass the front traveling vehicle mA in a range of a time required for the lane change of the host vehicle M, the lane change feasibility determination unit 123 determines that the lane change of the host vehicle M to the target position TA set between the front reference vehicle mB and the rear reference vehicle mC is not possible.

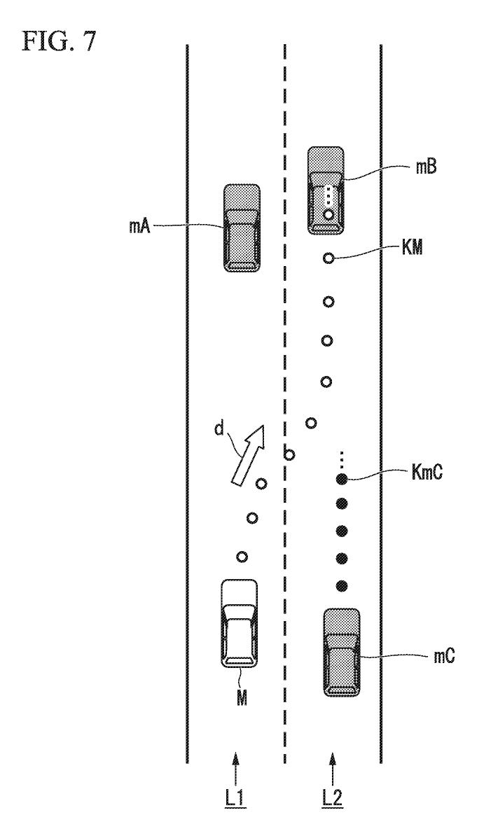

FIG. 7 is a diagram representing a mode in which the second track generation unit 124 generates a track in the first embodiment. For example, on the assumption that the front reference vehicle mB and the rear reference vehicle mC travel in a predetermined speed model, the second track generation unit 124 generates a track such that the host vehicle M is positioned between the front reference vehicle mB and the rear reference vehicle mC at a certain future time without interfering with the front traveling vehicle mA, on the basis of the speed models of these three vehicles and the speed of the host vehicle M.

For example, the second track generation unit 124 smoothly connects the current point (the current position) of the host vehicle M to the center of the lane that is the lane change destination and an end point of the lane change by using a polynomial curve such as a spline curve, and arranges a predetermined number of track points K on the curve at regular intervals or irregular intervals. The track points K may be allowed to correspond to the aforementioned track points, may include at least one of the track points, or may not include the track points. In this case, the second track generation unit 124 generates a track such that at least one of the track points K is arranged in the target position TA.

The interference determination unit 125 estimates a predicted track of another vehicle (for example, KmC illustrated in FIG. 7) based on positions of a nearby vehicle (for example, the rear reference vehicle mC illustrated in FIG. 7) for each predetermined future time. In addition, the interference determination unit 125 applies a constant speed model, an acceleration constant model, a jerk constant model and the like on the basis of a recognition result of the outside environment recognition unit 104 for the nearby vehicle (the rear reference vehicle mC), and generates a predicted track of another vehicle (an estimated track of another vehicle) on the basis of the applied model. The predicted track of another vehicle, for example, is generated as a set of track points at an interval of a predetermined time Δt (for example, 0.1 seconds) similarly to the target track of the host vehicle M.

Then, on the basis of a distance between a position (a track point) of the host vehicle M on the target track and a position corresponding to time among positions of the host vehicle M on the track and positions of the nearby vehicle (the rear reference vehicle mC) on the track, the interference determination unit 125 refers to the target track of the host vehicle M and the predicted track of another vehicle and determines whether there is interference between the target track of the host vehicle M and the predicted track of another vehicle.

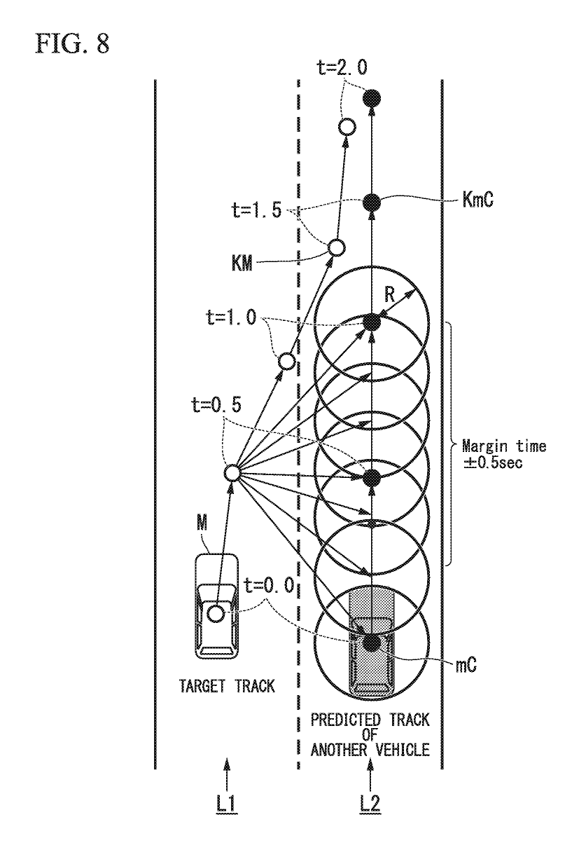

FIG. 8 is a diagram explaining interference determination between the target track of the host vehicle M and the predicted track of another vehicle. The example of FIG. 8 represents a mode of interference determination between the host vehicle M and the aforementioned rear reference vehicle mC on the tracks; however, it is possible to perform interference determination among the host vehicle M, the front traveling vehicle mA, and the front reference vehicle mB in a similar manner.

For example, the interference determination unit 125 measures an inter-point distance for each of one or a plurality of track points (the former is expressed as KM and the latter is expressed as KmC) on the target track of the host vehicle M and the predicted track of another vehicle, and determines the presence or absence of interference.

For example, the interference determination unit 125 extracts the track points KmC of the rear reference vehicle mC, which corresponds to an interval between a start time (T−margin time) obtained by subtracting the margin time from a time T and an end time (T+margin time) obtained by adding the margin time to the time T, with respect to the track point KM of the host vehicle M at the time T, and assumes circles having a predetermined radius R in which the extracted each track point KmC is employed as a center. Then, when the track point KM of the host vehicle M at the time T is not included in the assumed any circle (or is not in contact with the circle), the interference determination unit 125 determines that there is no interference at the time T. The margin time, for example, is set to about 0.5 seconds. The interference determination unit 125 performs such determination for a plurality of future times. In the example of FIG. 8, the interference determination unit 125 performs the determination for the track point KM of the host vehicle M at times t=0 second, t=0.5 seconds, t=1.0 seconds, t=1.5 seconds, and t=2.0 seconds.

The margin time is not a fixed value, and for example, may be a value which increases as a vehicle speed becomes fast. Furthermore, the size of the circle is not a fixed value, and for example, may be a value which increases as a vehicle speed becomes fast. Furthermore, setting the circles and performing the interference determination are illustrative purposes only, and similar determination can be performed by calculating an inter-point distance between the track point KM and the track point KmC.

In the first embodiment, in addition to the aforementioned primary determination, the lane change feasibility determination unit 123 determines as secondary determination that lane change is finally possible when it is determined by the interference determination unit 125 that there is no interference between the target track of the host vehicle M and the predicted track of another vehicle on the basis of an interference determination result of the target track of the host vehicle M and nearby vehicles (for example, the front reference vehicle mB and the rear reference vehicle mC). In addition, the lane change feasibility determination unit 123 may determine the lane change feasibility only by the aforementioned primary determination without referring to the interference determination result (the secondary determination) of the interference determination unit 125. Furthermore, the lane change feasibility determination unit 123 may also determine the lane change feasibility for each track point KM under the condition that acceleration/deceleration, a turning angle, an assumed yaw rate and the like are collected in a predetermined range.

Next, processing content when various processes in the aforementioned first embodiment are performed by a program installed at an in-vehicle computer of the host vehicle M will be described using flowcharts.

[Lane Change Control Process]

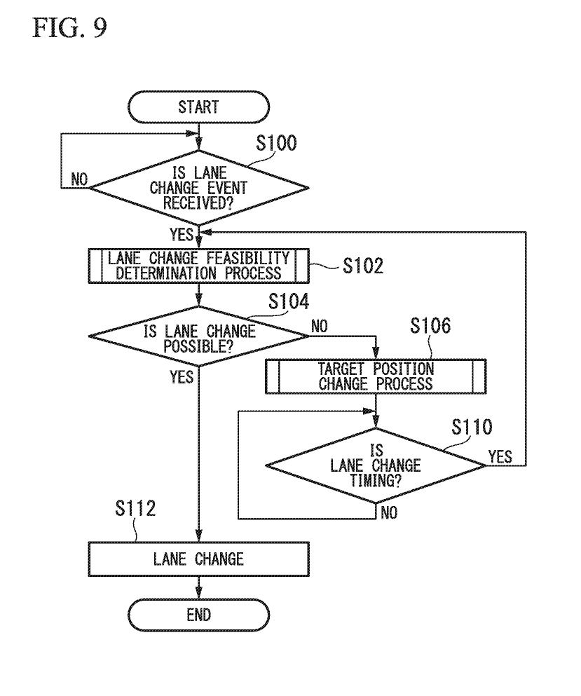

FIG. 9 is a flowchart representing an example of the lane change control process. Firstly, the lane change control unit 120 waits until the lane change event is received from the action plan generation unit 106 (step S100).

When the lane change event is received, the lane change control unit 120 performs a lane change feasibility determination process (step S102). Details of the process of the present step will be described later.

Next, the lane change control unit 120 determines whether lane change is possible as a result of the process of step S102 (step S104). When the lane change is not possible, the target position setting unit 122 performs a target position change process based on a speed result and the like of each lane specified by the respective lane speed specification unit 121 (step S106). Next, the lane change control unit 120 waits until a lane change timing is reached (step S108).

When the lane change timing is reached, the lane change control unit 120 returns to the process of step S102.

In the aforementioned process of step S104, when it is determined that the lane change is possible, the lane change control unit 120 allows a track to be output by the traveling control unit 130 and lane change to be performed (step S112).

[Lane Change Feasibility Determination Process]

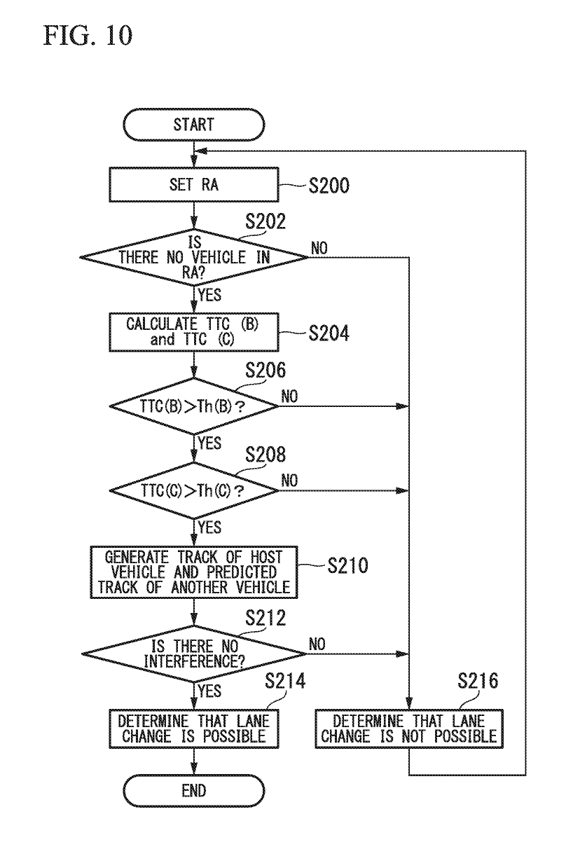

FIG. 10 is a flowchart representing an example of the lane change feasibility determination process in the first embodiment. The process in FIG. 10 corresponds to the aforementioned process of step S102 of FIG. 9. Firstly, the lane change feasibility determination unit 123 sets the inhibition area RA for the lane that is the lane change destination (step S200). Next, the lane change feasibility determination unit 123 determines whether some nearby vehicles do not exist in the inhibition area RA set in step S200 (step S202).

When the nearby vehicles do not exist in the inhibition area RA, the lane change feasibility determination unit 123 calculates the time to collision TTC (B) and the time to collision TTC (C) for the front reference vehicle mB and the rear reference vehicle mC (step S204).

Next, the lane change feasibility determination unit 123 determines whether TTC (B) for the front reference vehicle mB is larger than the threshold value Th (B) (step S206). When TTC (B) is larger than Th (B), the lane change feasibility determination unit 123 determines whether TTC (C) for the rear reference vehicle mC is larger than the threshold value Th (C) (step S208). When TTC (C) is larger than Th (C), the interference determination unit 125 generates a predicted track of another vehicle with respect to the front traveling vehicle mA, the front reference vehicle mB, and the rear reference vehicle mC (step S210).

Next, the interference determination unit 125 determines whether there is interference between the target track of the host vehicle M and the predicted track of another vehicle (step S212). When it is determined by the interference determination unit 125 that there is no interference, the lane change feasibility determination unit 123 determines that lane change of the host vehicle M to the lane that is the lane change destination is possible (step S214).

On the other hand, when it is determined by the interference determination unit 125 that there is the interference, the lane change feasibility determination unit 123 determines that the lane change is not possible (step S216) and returns to the process of step S200. In addition, an upper limit may be provided to the loop number of times of this repetition loop and when the upper limit is reached, the determination result indicating the non-possibility of the lane change may be repeated. Furthermore, the determination result indicating the non-possibility of the lane change may be repeated immediately without returning to the process of step S200 after it is determined that the lane change is not possible.

As described above, in the first embodiment, during the traveling of the host vehicle M, the lane change feasibility determination using the aforementioned first condition and second condition and the determination by the interference determination unit 125 are repeatedly performed, so that it is possible to appropriately perform the lane change feasibility according to a change in travel situations. In addition, in the first embodiment, the processes of steps S210 and S212 in the aforementioned lane change feasibility determination process may be omitted.

[Example of Target Position Change Process]

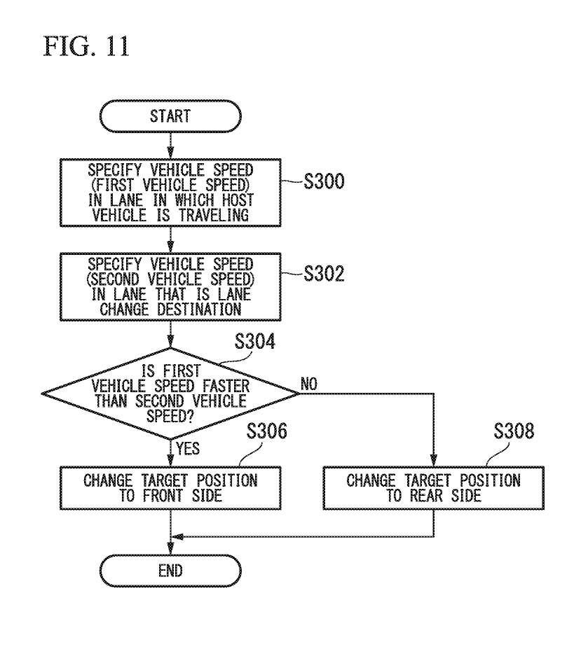

FIG. 11 is a flowchart representing an example of the target position change process. The process in FIG. 11 corresponds to the aforementioned process of step S106 of FIG. 9. Firstly, the respective lane speed specification unit 121 specifies a vehicle speed (the first vehicle speed) in the host lane (step S300). Next, the respective lane speed specification unit 121 specifies a vehicle speed (the second vehicle speed) in the lane that is the lane change destination (step S302).

Next, the target position setting unit 122 determines whether the first vehicle speed is faster than the second vehicle speed (step S304). When the first vehicle speed is faster than the second vehicle speed, the target position setting unit 122 changes the target position TA to a front side of the front reference vehicle mB (step S306). On the other hand, when the first vehicle speed is equal to or less than the second vehicle speed, the target position setting unit 122 changes the target position TA to a rear side of the rear reference vehicle mC (step S308).

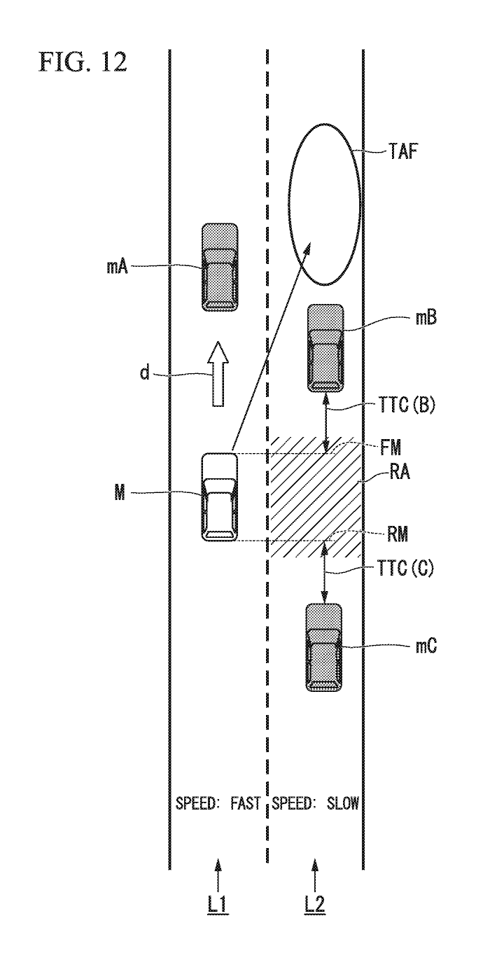

FIG. 12 is a diagram explaining a mode in which the target position is changed forward. The example in FIG. 12 corresponds to the aforementioned process of step S306. As described above, when it is determined that the lane change of the host vehicle M to the lane that is the lane change destination is not possible, the target position setting unit 122 specifies vehicle speeds (for example, the aforementioned first vehicle speed and second vehicle speed) of each lane as described above, and changes the target position TA on the basis of a comparison result of the speeds. In the example in FIG. 12, since the first vehicle speed is faster than the second vehicle speed, the changed target position TAF is set to the front side of the front reference vehicle mB.

As described above, when the new target position TAF is set, the lane change control unit 120 waits until a lane change timing is reached (for example, until the target position TAF is located at the lateral side of the host vehicle M), and the lane change process is performed at the time point at which the lane change timing is reached. In this case, the lane change control unit 120 may allow the traveling control unit 130 to perform speed adjustment control such that the host vehicle M approaches the target position TAF while allowing the traveling control unit 130 to accelerate the host vehicle M. In this way, it is possible to perform lane change more quickly.

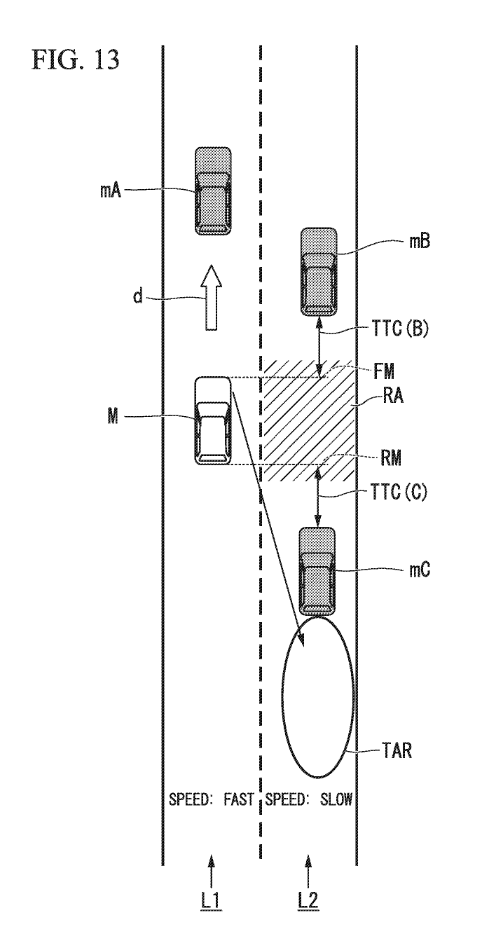

FIG. 13 is a diagram explaining a mode in which the target position is changed backward. The example in FIG. 13 corresponds to the aforementioned process of step S308. In the example in FIG. 13, since the first vehicle speed is equal to or less than the second vehicle speed, the changed target position TAR is set to the rear side of the rear reference vehicle mC.

As described above, when the new target position TAR is set, the lane change control unit 120 waits until a lane change timing is reached (for example, until the target position TAR is located at the lateral side of the host vehicle M), and the lane change process is performed at the time point at which the lane change timing is reached. In this case, the lane change control unit 120 may allow the traveling control unit 130 to perform speed adjustment control such that the host vehicle M approaches the target position TAR while allowing the traveling control unit 130 to decelerate the host vehicle M. In this way, it is possible to perform lane change more quickly.

Furthermore, immediately after the changed target position TAR is located at the lateral side of the host vehicle, the lane change control unit 120 may allow the traveling control unit 130 to perform speed adjustment control such that the speed of the host vehicle M is equal to the speed (the second vehicle speed) of the lane that is the lane change destination or the speeds (any one speed or an average speed) of vehicles travelling in front of or behind the target position TAR. In this way, it is possible to reduce an increase/decrease of a speed in subsequent lane change and to perform smooth lane change.

[Travel Control]

The traveling control unit 130 sets the control mode to the automatic driving mode or the manual driving mode under the control of the control switching unit 140, and controls a control target including a part or all of the travel driving force output device 90, the steering device 92, and the brake device 94 according to the set control mode. In the automatic driving mode, the traveling control unit 130 reads the action plan information 156 generated by the action plan generation unit 106, and controls the control target on the basis of an event included in the read action plan information 156. Furthermore, the traveling control unit 130 controls acceleration, deceleration, steering and the like of the host vehicle M such that the host vehicle M travels along a generated target track.

For example, when the event is the lane keeping event, the traveling control unit 130 determines a control amount (for example, the number of rotations) of the electric motor of the steering device 92 and a control amount (for example, the throttle opening of the engine, the shift stage and the like) of the ECU of the travel driving force output device 90 according to a track generated by the first track generation unit 112. Specifically, on the basis of a distance between the track points K and the predetermined time Δt when the track points K have been arranged, the traveling control unit 130 derives the speeds of the host vehicle M at every predetermined time Δt, and determines the control amount of the ECU of the travel driving force output device 90 according to the speeds at every predetermined time Δt. Furthermore, the traveling control unit 130 determines the control amount of the electric motor of the steering device 92 in accordance with an angle between the progress direction of the host vehicle M at every track point K and a direction of a next track point when the track point is employed as a reference.

Furthermore, when the event is the lane change event, the traveling control unit 130 determines the control amount of the electric motor of the steering device 92 and the control amount of the ECU of the travel driving force output device 90 according to a track generated by the first track generation unit 112 or the second track generation unit 124.

The traveling control unit 130 outputs information, which indicates the control amount determined for each event, to corresponding control targets. By so doing, the devices 90, 92, and 94 serving as the control target can control the host device according to information indicating the control amounts input from the traveling control unit 130. Furthermore, the traveling control unit 130 appropriately adjusts the determined control amounts on the basis of a detection result of the vehicle sensor 60.

Furthermore, in the manual driving mode, the traveling control unit 130 controls a control target on the basis of an operation detection signal output by the operation detection sensor 72. For example, the traveling control unit 130 outputs the operation detection signal output by the operation detection sensor 72 to each device serving as the control target as is.

The control switching unit 140 switches the control mode of the host vehicle M by the traveling control unit 130 from the automatic driving mode to the manual driving mode or from the manual driving mode to the automatic driving mode on the basis of the action plan information 156 generated by the action plan generation unit 106 and stored in the storage unit 150. Furthermore, on the basis of a control mode designation mode input from the switch 80, the control switching unit 140 switches the control mode of the host vehicle M by the traveling control unit 130 from the automatic driving mode to the manual driving mode or from the manual driving mode to the automatic driving mode. That is, the control mode of the traveling control unit 130 can be arbitrarily changed during traveling or stopping by an operation of a driver and the like.

Furthermore, on the basis of the operation detection signal output by the operation detection sensor 72, the control switching unit 140 switches the control mode of the host vehicle M by the traveling control unit 130 from the automatic driving mode to the manual driving mode. For example, when an operation amount included in the operation detection signal exceeds a threshold value, that is, when the operation device 70 receives an operation with an operation amount exceeding the threshold value, the control switching unit 140 switches the control mode of the traveling control unit 130 from the automatic driving mode to the manual driving mode. For example, in a case where the host vehicle M set to the automatic driving mode automatically travels by the traveling control unit 130, when a steering wheel, an accelerator pedal, or a brake pedal is operated with an operation amount exceeding the threshold value by a driver, the control switching unit 140 switches the control mode of the traveling control unit 130 from the automatic driving mode to the manual driving mode. In this way, when an object such as a person rushes out into a road or the front traveling vehicle mA suddenly stops, the vehicle control device 100 can immediately switch the control mode to the manual driving mode without the operation of the switch 80 by an operation instantaneously performed by a driver. As a consequence, the vehicle control device 100 can cope with an operation of a driver at the time of emergency and enhance traveling stability.

According to the vehicle control device 100, the vehicle control method, and the vehicle control program in the first embodiment described above, it is possible to appropriately perform the lane change feasibility determination on the basis of the presence or absence of a vehicle and the TTC in the inhibition area RA in the case of automatic driving control. Consequently, it is possible to perform lane change at an appropriate timing in accordance with travel situations of a vehicle in the lane change destination.

Furthermore, according to the first embodiment, in the case of satisfying both the first condition based on the presence or absence of another vehicle in the inhibition area RA and the second condition based on the time to collision with the other vehicle, it is determined that lane change is possible, so that it is possible to perform lane change at a more appropriate timing.

Furthermore, according to the first embodiment, it is determined whether there is interference in a travel position using a predicted track of the host vehicle M and another vehicle traveling in the lane that is the lane change destination and lane change is performed inclusive of the determination result, so that it is possible to perform the lane change feasibility determination more appropriately.

Furthermore, according to the first embodiment, the lane change feasibility determination is repeatedly performed, so that it is possible to perform lane change feasibility determination corresponding to a change in travel situations.

Furthermore, according to the first embodiment, when it is determined by the lane change feasibility determination unit 123 that lane change is not possible, a target position is changed on the basis of the first vehicle speed and the second vehicle speed specified by the respective lane speed specification unit 121, so that it is possible to set a target position of lane change more appropriately.

### Second Embodiment

Hereinafter, a second embodiment will be described. In the aforementioned first embodiment, in the case of satisfying both the case (the aforementioned first condition) where there is no vehicle in the inhibition area and the case (the aforementioned second condition) where the time to collision between the host vehicle M and nearby vehicles (for example, the front reference vehicle mB and the rear reference vehicle mC) is equal to or more than a threshold value, it is determined that the lane change of the host vehicle M to the lane change destination is possible. In the second embodiment, in the case of satisfying at least one of a plurality of conditions such as the aforementioned first condition and second condition, it is determined that the lane change of the host vehicle M to the lane change destination is possible.

In addition, in the second embodiment, since the content of the lane change feasibility determination process is different from that of the first embodiment and functional compositions and the like similar to those described in the first embodiment can be applied, a detailed description thereof is omitted and a difference will be mainly described.

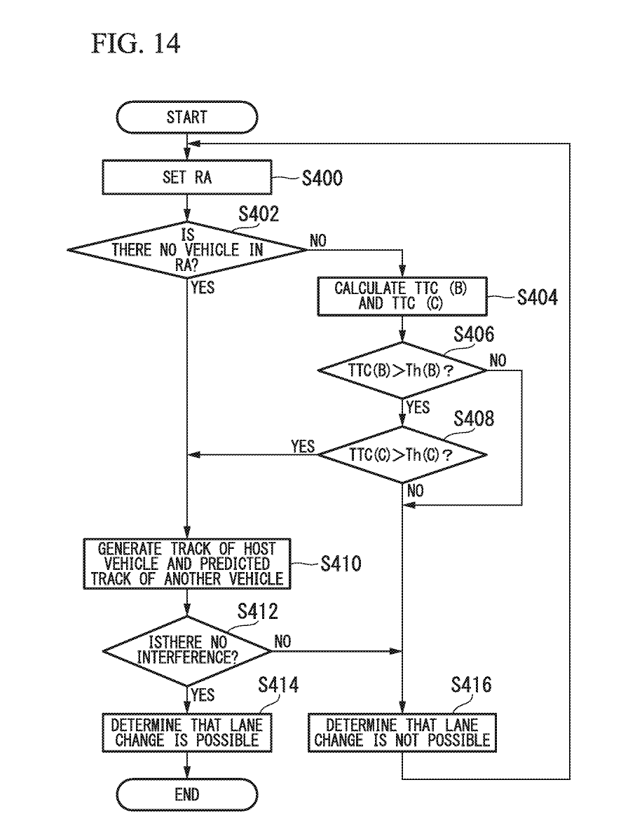

FIG. 14 is a flowchart representing an example of a lane change feasibility determination process in the second embodiment. In the example of FIG. 14, the lane change feasibility determination unit 123 firstly sets the inhibition area RA for the lane that is the lane change destination (step S400). Next, the lane change feasibility determination unit 123 determines whether some nearby vehicles do not exist in the inhibition area RA set in step S400 (step S402).

In the second embodiment, even though the nearby vehicles exist in the inhibition area RA, when a predetermined condition is satisfied for the time to collision, it is determined that lane change is possible. Consequently, when some nearby vehicles exist in the inhibition area RA, the lane change feasibility determination unit 123 calculates the time to collision TTC (B) and the time to collision TTC (C) for the front reference vehicle mB and the rear reference vehicle mC (step S404).

Next, the lane change feasibility determination unit 123 determines whether the time to collision TTC (B) is larger than the threshold value Th (B) (step S406). When the time to collision TTC (B) is larger than Th (B), the lane change feasibility determination unit 123 determines whether the time to collision TTC (C) is larger than the threshold value Th (C) (step S408). When the time to collision TTC (C) is larger than Th (C), the interference determination unit 125 generates predicted tracks (the target track of the host vehicle M and the predicted track of another vehicle) from current positions of the host vehicle M, the front reference vehicle mB, and the rear reference vehicle mC, which are obtained by the first track generation unit 112 (step S410). Furthermore, in the second embodiment, in step S402, when some nearby vehicles do not exist in the inhibition area RA, the target track of the host vehicle M and the predicted track of another vehicle are generated in a similar manner.

Next, on the basis of tracks of the host vehicle M and other vehicles (the front reference vehicle mB and the rear reference vehicle mC), the interference determination unit 125 determines whether there is interference between the vehicles (step S412). When it is determined by the interference determination unit 125 that there is no interference, the lane change feasibility determination unit 123 determines that lane change of the host vehicle M to the lane that is the lane change destination is possible (step S414).

On the other hand, when it is determined by the interference determination unit 125 that there is the interference, the lane change feasibility determination unit 123 determines that the lane change is not possible (step S416) and returns to the process of step S400. In addition, an upper limit may be provided to the loop number of times of this repetition loop and when the upper limit is reached, the determination result indicating the non-possibility of the lane change may be repeated. Furthermore, the determination result indicating the non-possibility of the lane change may be repeated immediately without returning to the process of step S400 after it is determined that the lane change is not possible.

According to the vehicle control device 100, the vehicle control method, and the vehicle control program in the second embodiment described above, when a first condition based on the presence or absence of another vehicle in the inhibition area RA is satisfied, it is possible to determine that lane change is possible. Even though the first condition is not satisfied, when a second condition based on the time to collision with the other vehicle is satisfied, it is possible to determine that the lane change is possible. In this way, in the second embodiment, it is possible to widen a permission range of the lane change as compared with the first embodiment. Furthermore, in the second embodiment, when the aforementioned first and second conditions are not satisfied, the lane change feasibility determination unit 123 determines that the lane change is not possible. According to another embodiment, for example, when the aforementioned second condition is not satisfied, the lane change feasibility determination unit 123 may perform determination based on the first condition and perform lane change feasibility determination on the basis of the determination result.

Although modes for embodying the present invention have been described using embodiments, the present invention is not limited to the embodiments and various types of modification and replacement can be made without departing from the scope of the present invention.

### REFERENCE SIGNS LIST

1 Vehicle control system
20 Finder
30 Radar
40 Camera
50 Navigation device
60 Vehicle sensor
70 Operation device
72 Operation detection sensor
80 Switch
90 Travel driving force output device
92 Steering device
94 Brake device
100 Vehicle control device
102 Host vehicle position recognition unit
104 Outside environment recognition unit
106 Action plan generation unit
110 Traveling mode determination unit
112 First track generation unit
120 Lane change control unit
121 Respective lane speed specification unit
122 Target position setting unit
123 Lane change feasibility determination unit
124 Second track generation unit
125 Interference determination unit
130 Traveling control unit
140 Control switching unit
150 Storage unit
M Host vehicle

What is claim is:

1. A vehicle control device comprising:
a recognition unit configured to recognize positions of nearby vehicles traveling around a host vehicle;
a respective lane speed specification unit configured to specify a first vehicle speed related to a vehicle traveling in a host lane in which the host vehicle is traveling and a second vehicle speed related to a nearby vehicle traveling in a lane that is a lane change destination of lane change to be performed by the host vehicle;
a target position setting unit configured to set a lane change target position on the lane that is the lane change destination on the basis of a comparison result between the first vehicle speed and the second vehicle speed; and
a control unit configured to cause the host vehicle to move to the target position by lane change,
wherein, when the nearby vehicle traveling in the lane that is the lane change destination and traveling in front of the host vehicle is set as a front reference vehicle and the nearby vehicle traveling in the lane that is the lane change destination and traveling behind the host vehicle is set as a rear reference vehicle,
the target position setting unit sets a front side of the front reference vehicle as the target position when the first vehicle speed is faster than the second vehicle speed and sets a rear side of the rear reference vehicle as the target position when the first vehicle speed is slower than the second vehicle speed.

2. The vehicle control device according to claim 1, further comprising:
a lane change feasibility determination unit configured to determine whether lane change of the host vehicle to the first target position is possible,
wherein, when it is determined by the lane change feasibility determination unit that the lane change is not possible, the target position setting unit sets the target position again on the basis of the first vehicle speed and the second vehicle speed.

3. (canceled)

4. The vehicle control device according to claim 1, wherein the respective lane speed specification unit specifies, as the first vehicle speed, a vehicle speed average value obtained from one or a plurality of nearby vehicles traveling in the host lane and/or the host vehicle, and specifies, as the second vehicle speed, a vehicle speed average value of one or a plurality of nearby vehicles traveling in the lane that is the lane change destination.

5. The vehicle control device according to claim 1, wherein the respective lane speed specification unit specifies the second vehicle speed by using speed information obtained from a predetermined number of nearby vehicles sequentially near the host vehicle among the nearby vehicles traveling in the lane that is the lane change destination.

6. The vehicle control device according to claim 1, wherein the respective lane speed specification unit specifies one or both of the first vehicle speed and the second vehicle speed as a fixed value.

7. The vehicle control device according to claim 1, wherein, when the target position is located in front of the host vehicle, the control unit performs speed adjustment such that the host vehicle approaches the target position while accelerating the host vehicle.

8. The vehicle control device according to claim 1, wherein, when the target position is located behind the host vehicle, the control unit decelerates the host vehicle, and immediately after the target position is located at a lateral side of the host vehicle, the control unit performs speed adjustment such that a speed of the host vehicle is equal to the second vehicle speed or a speed of a nearby vehicle travelling in front of or behind the target position.

9. A vehicle control method comprising:
recognizing, by an in-vehicle computer, positions of nearby vehicles traveling around a host vehicle;
specifying, by the in-vehicle computer, a first vehicle speed related to a vehicle traveling in a host lane in which the host vehicle is traveling and a second vehicle speed related to a nearby vehicle traveling in a lane that is a lane change destination of lane change to be performed by the host vehicle;
setting, by the in-vehicle computer, a lane change target position on the lane that is the lane change destination on the basis of a comparison result between the first vehicle speed and the second vehicle speed; and
causing, by the in-vehicle computer, the host vehicle to move to the target position by lane change,
wherein the vehicle control method further comprises;
when the nearby vehicle traveling in the lane that is the lane change destination and traveling in front of the host vehicle is set as a front reference vehicle and the nearby vehicle traveling in the lane that is the lane change destination and traveling behind the host vehicle is set as a rear reference vehicle,
setting, by the in-vehicle computer, a front side of the front reference vehicle as the target position when the first vehicle speed is faster than the second vehicle speed; and
setting, by the in-vehicle computer, a rear side of the rear reference vehicle as the target position when the first vehicle speed is slower than the second vehicle speed.

10. A vehicle control program causing an in-vehicle computer to perform a process comprising:
recognizing positions of nearby vehicles traveling around a host vehicle;
specifying a first vehicle speed related to a vehicle traveling in a host lane in which the host vehicle is traveling and a second vehicle speed related to a nearby vehicle traveling in a lane that is a lane change destination of lane change to be performed by the host vehicle;
setting a lane change target position on the lane that is the lane change destination on the basis of a comparison result between the first vehicle speed and the second vehicle speed; and
causing the host vehicle to move to the target position by lane change,
wherein the vehicle control program causing the in-vehicle computer to perform a process further comprises:
when the nearby vehicle traveling in the lane that is the lane change destination and traveling in front of the host vehicle is set as a front reference vehicle and the nearby vehicle traveling in the lane that is the lane change destination and traveling behind the host vehicle is set as a rear reference vehicle,
setting, by the in-vehicle computer, a front side of the front reference vehicle as the target position when the first vehicle speed is faster than the second vehicle speed; and
setting, by the in-vehicle computer, a rear side of the rear reference vehicle as the target position when the first vehicle speed is slower than the second vehicle speed.
